(19) United States
(12) Patent Application Publication
(10) Pub. No.: US 2026/0178221 A1
(43) Pub. Date: Jun. 25, 2026

(54) BLOCK AND DIE FAMILY VARIATION MANAGEMENT TECHNIQUE FOR A MEMORY SUB-SYSTEM

(71) Applicant: MICRON TECHNOLOGY, INC., Boise, ID (US)

(72) Inventors: Aaron Lee, Sunnyvale, CA (US); Yang Liu, San Jose, CA (US); Zhenlei Shen, Milpitas, CA (US); Xinyang Cao, San Jose, CA (US)

(21) Appl. No.: 19/423,646

(22) Filed: Dec. 17, 2025

Related U.S. Application Data
(60) Provisional application No. 63/737,385, filed on Dec. 20, 2024.

(51) Int. Cl. G06F 3/06

(52) U.S. Cl. CPC G06F 3/0655; G06F 3/0604; G06F 3/0679

(57) ABSTRACT

A measure associated with a characteristic of each die of a plurality of dies of a memory device is obtained. A die family distribution policy is identified. The die family distribution policy indicates a size capacity for each die family of a plurality of die families. The size capacity corresponds to the measure of each die. Each die of the plurality of dies is associated with a die family of the plurality of die families according to the die family distribution policy.

### CROSS-REFERENCE TO RELATED APPLICATION

This present application claims priority to U.S. Provisional Patent Application No. 63/737,385, filed on December 20, 2024, and entitled “Block And Die Family Variation Management Technique For A Memory Sub-System,” the entire contents of which are hereby incorporated reference herein.

### TECHNICAL FIELD

Embodiments of the disclosure relate generally to memory sub-systems, and more specifically, relate to block and die family variation management technique for a memory sub-system.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an example computing system that includes a memory sub-system in accordance with some embodiments of the present disclosure.

FIG. 2 illustrates example metadata maintained by the memory sub-system controller 115 for associating dies with die families, in accordance with some embodiments of the present disclosure.

FIG. 3 illustrates example metadata maintained by the memory sub-system controller 115 for associating blocks with blocks families, in accordance with some embodiments of the present disclosure.

FIG. 4 illustrates an example of the threshold voltage shifts for each logical programming level of a die measured by the family variation component, in accordance with some embodiments of the present disclosure.

FIG. 5 is a flow diagram of an example method to distribute dies into die families, in accordance with some embodiments of the present disclosure

FIG. 6 is a flow diagram of an example method to distribute block into block families, in accordance with some embodiments of the present disclosure

FIG. 7 is a block diagram of an example computer system in which embodiments of the present disclosure may operate.

### DETAILED DESCRIPTION

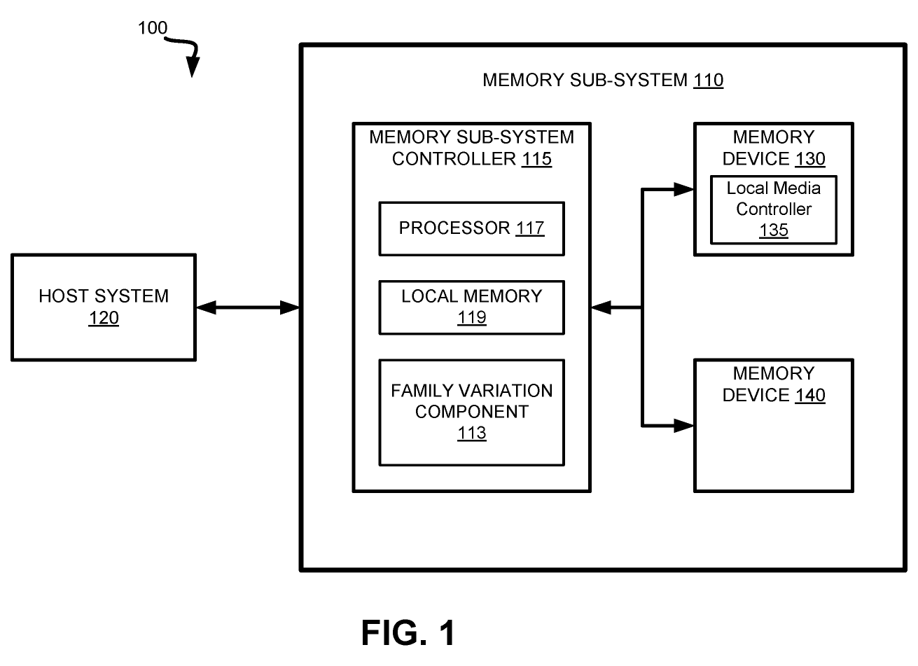

Aspects of the present disclosure are directed to block and die family variation management technique for a memory sub-system. A memory sub-system can be a storage device, a memory module, or a combination of a storage device and memory module. Examples of storage devices and memory modules are described below in conjunction with FIG. 1. In general, a host system can utilize a memory sub-system that includes one or more components, such as memory devices that store data. The host system can provide data to be stored at the memory sub-system and can request data to be retrieved from the memory sub-system.

A memory sub-system can include high density non-volatile memory devices where retention of data is desired when no power is supplied to the memory device. One example of non-volatile memory devices is a not-and (NAND) memory device. Other examples of non-volatile memory devices are described below in conjunction with FIG. 1. A non-volatile memory device is a package of one or more dies. Each die can include one or more planes. For some types of non-volatile memory devices (e.g., NAND devices), each plane includes of a set of physical blocks. Each block includes of a set of pages. Each page includes of a set of memory cells (“cells”). A cell is an electronic circuit that stores information. Depending on the cell type, a cell can store one or more bits of binary information, and has various logic states that correlate to the number of bits being stored. The logic states can be represented by binary values, such as “0” and “1”, or combinations of such values.

A memory device can be made up of bits arranged in a two-dimensional or a three-dimensional grid. Memory cells are formed onto a silicon wafer in an array of columns (also hereinafter referred to as bitlines) and rows (also hereinafter referred to as wordlines). A wordline can have a row of associated memory cells in a memory device that are used with one or more bitlines to generate the address of each of the memory cells. The intersection of a bitline and wordline constitutes the address of the memory cell. A block hereinafter refers to a unit of the memory device used to store data and can include a group of memory cells, a wordline group, a wordline, or individual memory cells. One or more blocks can be grouped together to form separate partitions (e.g., planes) of the memory device in order to allow concurrent operations to take place on each plane. The memory device can include circuitry that performs concurrent memory page accesses of two or more memory planes. For example, the memory device can include multiple access line driver circuits and power circuits that can be shared by the planes of the memory device to facilitate concurrent access of pages of two or more memory planes, including different page types. For ease of description, these circuits can be generally referred to as independent plane driver circuits. Depending on the storage architecture employed, data can be stored across the memory planes (i.e., in stripes). Accordingly, one request to read a segment of data (e.g., corresponding to one or more data addresses), can result in read operations performed on two or more of the memory planes of the memory device.

A memory cell (“cell”) can be programmed (e.g., written to) by applying a certain voltage to the cell, which results in an electric charge being held by the cell. For example, a voltage signal V_{CG} can be applied to a control electrode of the cell to open the cell to the flow of electric current across the cell between a source electrode and a drain electrode. More specifically, for each individual cell (having a charge Q stored thereon), there can be a threshold control gate voltage V_{T} (also referred to as the “threshold voltage”) such that the source-drain electric current is low for the control gate voltage (V_{CG}) being below the threshold voltage, V_{CG} < V_{T}. The current increases substantially once the control gate voltage has exceeded the threshold voltage, V_{CG} > V_{T.} Because the actual geometry of the electrodes and gates varies from cell to cell, the threshold voltages can be different even for cells implemented on the same die. The cells can, therefore, be characterized by a distribution P of the threshold voltages, P(Q,V_{T}) =dW/dV_{T}, where dW represents the probability that any given cell has its threshold voltage within the interval [V_{T},V_{T} +dV_{T}] when charge Q is placed on the cell.

A memory device can exhibit threshold voltage distributions P(Q,V_{T}) that are narrow compared with the working range of control voltages tolerated by the cells of the device. Accordingly, multiple non-overlapping distributions P(Qₖ,V_{T}) (“valleys”) can be fit into the working range, allowing for storage and reliable detection of multiple values of the charge Qₖ , k=1, 2, 3… The distributions (valleys) are interspersed with voltage intervals (“valley margins”) where none (or very few) of the cells of the device have their threshold voltages. Such valley margins can, therefore, be used to separate various charge states Qₖ. The logical state of the cell can be determined by detecting, during a read operation, between which two valley margins the respective threshold voltage V_{T} of the cell resides. Specifically, the read operation can be performed by comparing the measured threshold voltage V_{T} exhibited by the memory cell to one or more reference voltage levels corresponding to known valley margins (e.g., centers of the margins) of the memory device.

One type of cell is a single level cell (SLC), which stores 1 bit per cell and defines 2 logical states (“states”) (“1” or “L0” and “0” or “L1”), each corresponding to a respective V_{T} level. For example, the “1” state can be an erased state (L0), and the “0” state can be a programmed state (L1). Another type of cell is a multi-level cell (MLC), which stores 2 bits per cell and defines 4 states (“11” or “L0”, “10” or “L1”, “01” or “L2” and “00” or “L3”), each corresponding to a respective V_{T} level. For example, the “11” state can be an erased state, and the “01”, “10” and “00” states can each be a respective programmed state. Another type of cell is a triple level cell (TLC), which stores 3 bits per cell and defines 8 states (“111” or “L0”, “110” or “L1”, “101” or “L2”, “100” or “L3”, “011” or “L4”, “010” or “L5”, “001” or “L6”, and “000” or “L7”), each corresponding to a respective V_{T} level. For example, the “111” state can be an erased state, and each of the other states can be a respective programmed state. Another type of a cell is a quad-level cell (QLC), which stores 4 bits per cell and defines 16 states L0-L15, where L0 corresponds to “1111” and L15 corresponds to “0000”. Another type of cell is a penta-level cell (PLC), which stores 5 bits per cell and defines 32 states. Other types of cells are also contemplated. A memory device can include one or more arrays of memory cells such as SLCs, MLCs, TLCs, QLCs, PLCs, etc., or any combination of such. For example, a memory device can include an SLC portion, an MLC portion, a TLC portion, a QLC portion, or a PLC portion of cells.

A valley margin can also be referred to as a read window. For example, in an SLC cell, there is 1 read window that exists with respect to the 2 V_{T} distributions. As another example, in an MLC cell, there are 3 read windows that exist with respect to the 4 V_{T} distributions. As yet another example, in a TLC cell, there are 7 read windows that exist with respect to the 8 V_{T} distributions. Read window size generally decreases as the number of states increases. For example, the 1 read window for the SLC cell may be larger than each of the 3 read windows for the MLC cell, and each of the 3 read windows for the MLC cell may be larger than each of the 7 read windows for the TLC cell, etc.

As data is repeatedly written and erased in a memory device, such as a flash memory device, the memory device may be more susceptible to errors due to various types of noise and disturb mechanisms inherent within the memory cells, which may be exacerbated with repeated programming. As a result, the raw bit error rates (RBERs) for the memory device can increase over time. Given this pattern, the end-of-life RBERs for these devices are much higher as compared to the beginning-of-life RBERs for the respective devices.

To address read errors, a memory sub-system can use an error handling technique to correct errors and verify that the data written into the memory device is the same as the data being read from the respective memory device. In some embodiments, the error handling technique can include performing one or more read retries using different parameters, such as a change in the threshold voltage offset as compared to the initial threshold voltage offset applied in performing a read operation on a set of memory cells.

One phenomenon observed in memory devices is slow charge loss (SCL), which can occur as a function of elapsed time since programming and/or temperature. Charge loss can cause a V_{T} distribution shift, in which V_{T} distributions shift towards lower voltage levels. That is, the V_{T} distribution shift can be proportional to the elapsed time from a programming operation to a read operation and/or temperature. Charge loss and the corresponding V_{T} distribution shift can, over time, lead to increasing bit error rates (e.g., raw bit error rates (RBERs)) that require increasing amounts of error correction to address, and, accordingly, increasing amounts of system resources.

Depending on the system workload and program-erase cycles, the elapsed times since programming may vary across blocks. These variations in the elapsed time since programming can result in varying, non-uniform V_{T} distribution shifts of respective blocks if the programming of blocks is spaced significantly in time. As a result of these non-uniform V_{T} distribution shifts, it can be difficult to predict an optimal threshold voltage offset that needs to be applied to the majority of the blocks across wordlines to address charge loss without compromising performance.

In some memory sub-systems, the charge loss can be tracked by implementing block family error avoidance (BFEA), which involves assigning blocks of a memory device to a respective predefined block family (BF). “Block family” can refer to a possibly noncontiguous set of memory cells (which can reside in one or more full and/or partial blocks, the latter referred to as “partitions” herein) that have been programmed within a specified time window and a specified temperature window, and thus are expected to exhibit similar or correlated changes in their respective data state metrics. Thus, each BF can define a grouping of blocks having a substantially similar elapsed time since programming (e.g., are programmed at or around the same time). Since the time elapsed after programming and temperature are the main factors affecting the temporal voltage shift, all blocks and/or partitions within a single block family are presumed to exhibit similar distributions of threshold voltages in memory cells, and thus would require the same voltage offsets to be applied to the base read levels for read operations. “Base read level” herein shall refer to the initial threshold voltage level exhibited by the memory cell immediately after programming. In some implementations, base read levels can be stored in the metadata of the memory device.

Each BF can be assigned to a respective threshold voltage offset bin (“bin”), where each BFEA bin includes a set of threshold level offsets to be applied to respective programming voltage levels to account for V_{T} distribution shifts over time resulting from the slow charge loss. As mentioned above, the amount of charge loss of a block can be a function of the elapsed time from a programming operation and/or temperature. Each BFEA bin can be assigned a respective bin index representing a bin number.

When a block is initially programmed at time 0, the block can be initially assigned to the currently open BF, where the currently open BF is associated with a first bin (e.g., bin 1). A media scan operation can be performed on representative blocks of each BF at a particular respective V_{T} level periodically (e.g., every few hours) to determine whether the threshold voltage offset for a block, and thus the BFEA bin assignment, should be updated to better track V_{T} distribution shift over time. For example, if the media scan operation indicates that the threshold voltage offset should be updated to the threshold voltage offset assigned to a second bin (e.g., bin 2), then the block can be reassigned to the second bin.

Additionally or alternatively, some memory sub-systems can implement die family based error avoidance strategies, in which each die of a memory device is assigned to a die family. “Die family” can refer to a set of die that exhibit similar temporal voltage shift and therefore have the same threshold voltage offset bin pointers. A memory sub-system can form a die family corresponding to a time after program (TAP). The die family can include a number of die that behave similarly in terms of temporal voltage shift. The memory sub-system can associate each die family with a predefined read threshold voltage offset bin, to offset the V_{T} distribution shift of the cells within the die. Periodically, a calibration process to associate each die family with a predefined read threshold voltage offset bin can be performed. To perform a calibration process, one or more data state metric values reflecting the temporal voltage shift characteristics can be determined for one or more representative die of a die family. The determined temporal voltage shift characteristics of the representative die of the die family can be used to set a modified threshold voltage offset bin for each of the die in the die family. “Data state metric” herein shall refer to a quantity that is measured or inferred from the state of data stored on a memory device. Specifically, the data state metrics may reflect the state of the temporal voltage shift, the degree of read disturb, and/or other measurable functions of the data state. A composite data state metric is a function (e.g., a weighted sum) of a set of component state metrics.

In some instances, however, the process of assigning dies to die families can results in a majority of the dies being assigned to a particular die family. Thus, a single threshold level offset (i.e., the threshold level offset associated with the particular die family to which the majority of dies are assigned) is then used to offset the threshold voltage shift for the majority of dies. Similarly, in some instances, the majority of blocks can be assigned to a particular block family, resulting in a single threshold level offset (associated with the particular block family) being applied the majority of blocks. Relying on a single threshold level offset to correct the threshold voltage shift for a majority of dies and/or blocks can lead to a higher instance of inaccurate read results, especially for the blocks on the tail ends of the V_{T} distribution for the particular die family or block family.

Taking die families as an illustrative example, the V_{T} distribution of dies assigned to a particular die family can fall within a V_{T} distribution range of values. The V_{T} distribution typically follows a Gaussian distribution, in which the V_{T} distribution of the majority (e.g., two thirds) of the dies assigned to the particular die family may fall within one standard deviation of the mean V_{T} distribution, while the V_{T} distribution of a few (e.g., around five percent) of the dies assigned to the particular die family may fall within two standard deviations of the mean V_{T} distribution for the die family. The threshold level offset for a particular die family can correspond to (e.g., offset) the mean V_{T} distribution of the dies assigned to the particular die family. Thus, when the dies of a memory device are somewhat evenly distributed among the die families, the number of errors caused by the five percent of dies that have two standard deviations from the mean V_{T} distribution can be manageable by the memory sub-system controller, e.g., using error handling techniques. However, when the majority (e.g., ninety percent) of the dies of a memory device are assigned to a particular die family, the number of errors for the five percent of the dies that are within two standard deviations of the mean V_{T} distribution for the die family may no longer be manageable by the memory sub-system controller. That is, as the number of dies assigned to a particular die family increases, so can the number of errors in read operations implemented using the read level offset corresponding to the particular die family. A similar deficiency applies to block families. That is, as more blocks are associated with a particular block family, a single read level offset can be used to offset the V_{T} distribution of the blocks assigned to the block family. As the number of blocks assigned to a particular block family increases, so can the number of errors in read operations implemented using the single read level offset associated with the block family. The number of errors may become unmanageable by the memory sub-system controller’s error handling techniques, causing overall system latency and poor quality of service for the memory sub-system.

Aspects of the present disclosure address the above-noted and other deficiencies by providing a memory sub-system that implements one or more distribution policies to achieve a balanced distribution of dies and blocks of a memory device across the various die families and block families, respectively. The memory sub-system controller can then assign an appropriate read level offset to each die family and/or block family, reflecting a measure of a characteristic of the dies/blocks assigned to the respective block family/die family.

In some embodiments, the memory sub-system controller can identify a die family distribution policy. The die family distribution policy can be stored in local memory of the memory sub-system, for example. The die family distribution policy can indicate a size capacity for each die family of the die families of a memory device. The size capacity can reflect the number of dies assigned to a particular die family. The size capacity can be a maximum number of dies that can be assigned to a particular die family, and/or can be relative to the size capacities of the other die families. For example, the size capacity can limit the size of a die family to be within a certain range of the sizes of the other die families. As an illustrative example, the size capacity can limit the number of dies assigned to the die family to a percentage of dies of the memory devices (e.g., twenty percent).

Additionally or alternatively, the size capacity can correspond to a measure associated with a characteristic of the dies of the memory device. The characteristic can be, for example, slow charge loss, read disturb, data integrity, endurance, operational temperature, dynamic wear, or static wear. A measure that quantifies the characteristic(s) associated with the die can be obtained. In some examples, the measure can be associated with various data state metrics. For example, the measure can be derived from a data state metric. In some examples, the measure can represent a temporal voltage shift (TVS), a voltage offset, a raw bit error rate (RBER), a rate of slow charge loss, or a combination thereof.

In some embodiments, the memory sub-system controller can determine the measure associated with a characteristic of the dies of the memory device. For example, the memory sub-system controller can measure the voltage shift of the highest valley of the cells of the die. As an illustrative example, for a TLC, the memory sub-system controller can measure the voltage shift for the valley between L6 and L7. In some embodiments, the memory sub-system controller can obtain or determine the measure associated with the characteristic of the dies in response to a triggering event (e.g., after every 1,000 program/erase cycles, in response to determining that a die has reached a maximum threshold side), and/or upon a power-on event of the memory sub-system. In some embodiments, the memory sub-system controller can obtain or determine the measure associated with the characteristic of the dies after identifying the die family distribution policy. In some embodiments, the memory sub-system controller can sort the dies according to the determined measure. The memory sub-system controller can then apply the die family distribution policy to the sorted dies of the memory device.

As an illustrative example, the die family distribution policy can specify that each die family should be assigned an equal (or close to equal) number of dies. For example, if there are five die families, then each die family should be assigned around 20% of the dies. Once the dies are sorted according to the measured characteristic, the memory sub-system controller can assign the first 20% of die families to the first die family, the second 20% of die families to the die family, and so on. In some implementations, however, the result of the sorting may not allow for an equal distribution. For example, if the dies falling within the 18-22% range of the sorted dies have the same characteristic measure, splitting the dies at the 20% line may not be ideal, since 2% of dies that have a characteristic measure of x will be assigned to the first die family (and thus will be associated a first threshold voltage offset), and 2% of the dies that have a characteristic measure of x will be assigned to the second die family (and thus will be associated with a second threshold voltage offset). Thus, the die family distribution policy can allow for some flexibility when assigning the dies to die families. In some embodiments, the die family distribution policy can enforce a maximum number of dies assigned to each die family, or a maximum percentage of dies assigned to each die family, relative to the percentage of dies assigned to other die families.

The memory sub-system controller can then determine a read offset value for each of the die families. The read offset value can be based on the measure associated with the characteristic of each of the dies. The read offset value can be an average of the measure associated with the characteristics of each of the dies assigned to the die family. Thus, the read offset value can offset the threshold voltage of the dies in the die family. The memory sub-system controller can assign the read offset value with the die family.

In some embodiments, additionally or alternatively, the memory sub-system controller can implement a block family distribution policy for the blocks of a memory device. In some embodiments, the memory sub-system controller can obtain a measure associated with a characteristic of a number of blocks of the memory device (e.g., each block of a group of blocks, or each block of the memory device). Since block families are created as they are cells are being programmed, in some embodiments, the memory sub-system controller can obtain the measure in response to determining that a block family has reached a threshold size (e.g., has gotten too big). In some implementations, the threshold size can be relative to the size of the other block families. The memory sub-system controller can implement a block family distribution policy, which can indicate a size capacity for each block family. Similar to die families, the size capacity for block families can correspond to the characteristic measure of the blocks. The memory sub-system controller can then associate each block with a corresponding block family according to the block family distribution policy. The memory sub-system controller can determine a read level offset for each block family, based on an average of the characteristic measures of the blocks assigned to the block family.

Advantages of the present disclosure include, but are not limited to, improving the bit error rate in read operations by more evenly distributing blocks across block families and/or more evenly distributing dies across die families. By setting a limit to how many dies can be assigned to a die family (and/or how many blocks can be assigned to a block family), aspects of the present disclosure avoid instances in which a single read level offset is used to offset the voltage threshold distribution of a majority of the dies and/or blocks. This can result in a reduction in read errors, and thus a reduction in error correction operations. Overall, aspects of the present disclosure can improve the reliability and performance of the memory sub-system.

FIG. 1 illustrates an example computing system 100 that includes a memory sub-system 110 in accordance with some embodiments of the present disclosure. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a combination of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to multiple memory sub-systems 110 of different types. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller, CXL controller).

The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include, but are not limited to, a serial advanced technology attachment (SATA) interface, a compute express link (CXL) interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface can be used to transmit data between the host system 120 and the memory sub-system 110. The host system 120 can further utilize an NVM Express (NVMe) interface to access components (e.g., memory devices 130) when the memory sub-system 110 is coupled with the host system 120 by the physical host interface (e.g., PCIe or CXL bus). The physical host interface can provide an interface for passing control, address, data, and other signals between the memory sub-system 110 and the host system 120. FIG. 1 illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device 130) include a not-and (NAND) type flash memory and write-in-place memory, such as a three-dimensional cross-point (“3D cross-point”) memory device, which is a cross-point array of non-volatile memory cells. A cross-point array of non-volatile memory cells can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 130 can include one or more arrays of memory cells. One type of memory cell, for example, single level cells (SLC) can store one bit per cell. Other types of memory cells, such as multi-level cells (MLCs), triple level cells (TLCs), quad-level cells (QLCs), and penta-level cells (PLCs) can store multiple bits per cell. In some embodiments, each of the memory devices 130 can include one or more arrays of memory cells such as SLCs, MLCs, TLCs, QLCs, PLCs or any combination of such. In some embodiments, a particular memory device can include an SLC portion, and an MLC portion, a TLC portion, a QLC portion, or a PLC portion of memory cells. The memory cells of the memory devices 130 can be grouped as pages that can refer to a logical unit of the memory device used to store data. With some types of memory (e.g., NAND), pages can be grouped to form blocks.

Although non-volatile memory components such as a 3D cross-point array of non-volatile memory cells and NAND type flash memory (e.g., 2D NAND, 3D NAND) are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), not-or (NOR) flash memory, or electrically erasable programmable read-only memory (EEPROM).

A memory sub-system controller 115 (or controller 115 for simplicity) can communicate with the memory devices 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processing device, which includes one or more processors (e.g., processor 117), configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, etc. The local memory 119 can also include read-only memory (ROM) for storing micro-code. While the example memory sub-system 110 in FIG. 1 has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory devices 130. The memory sub-system controller 115 can be responsible for other operations such as wear leveling operations, garbage collection operations, error detection and error-correcting code (ECC) operations, encryption operations, caching operations, and address translations between a logical address (e.g., a logical block address (LBA), namespace) and a physical address (e.g., physical block address) that are associated with the memory devices 130. The memory sub-system controller 115 can further include host interface circuitry to communicate with the host system 120 via the physical host interface. The host interface circuitry can convert the commands received from the host system into command instructions to access the memory devices 130 as well as convert responses associated with the memory devices 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory devices 130.

In some embodiments, the memory devices 130 include local media controllers 135 that operate in conjunction with memory sub-system controller 115 to execute operations on one or more memory cells of the memory devices 130. An external controller (e.g., memory sub-system controller 115) can externally manage the memory device 130 (e.g., perform media management operations on the memory device 130). In some embodiments, memory sub-system 110 is a managed memory device, which is a raw memory device 130 having control logic (e.g., local media controller 135) on the die and a controller (e.g., memory sub-system controller 115) for media management within the same memory device package. An example of a managed memory device is a managed NAND (MNAND) device.

The memory sub-system 110 includes a family variation component 113 that can implement distribution policies for the die families and/or block families of a memory device (e.g., memory device 130). In some embodiments, the memory sub-system controller 115 includes at least a portion of the family variation component 113. In some embodiments, the family variation component 113 is part of the host system 120, an application, or an operating system. In other embodiments, local media controller 135 includes at least a portion of family variation component 113 and is configured to perform the functionality described herein.

The family variation component 113 can identify a block family distribution policy and/or a die family distribution policy, e.g., stored in local memory 119. The block family distribution policy can provide a framework for distributing the blocks among the block families, and the die family distribution policy can provide a distribution framework for distributing the dies among the die families.

In some embodiments, the framework outlined by the die family distribution policy can include a number of die families, and a size capacity for each die family. In some embodiments, the size capacity is a maximum number of dies. Additionally or alternatively, the size capacity is relative to the size capacities of the other die families. For example, the size capacity can be percentage range of the number of dies. As an illustrative example, the die family distribution policy can allow for five die families, and the size capacity of each die family can be 18-22% of the total number of dies. For a memory device that has 255 dies, a die family can have a size capacity of 45-57 dies. The size capacity avoids having one die family from becoming too big.

In some embodiments, the family variation component 113 can obtain a measure of a characteristic of each die. The characteristic can be, for example, SCL, read disturb, data integrity, endurance, operational temperature, dynamic wear, or static wear. A measure which quantifies the characteristics associated with the die can be obtained. In some examples, the measure can be associated with various data state metrics, as discussed previously. In some examples, the measure can be associated with a temporal voltage shift (TVS), a voltage offset, a threshold voltage offset bin, a raw bit error rate (RBER), a rate of slow charge loss, or a combination thereof. In some examples, the measure can be the value that quantifies the characteristic (e.g., an RBER), wherein in other examples, the measure can be a calculation performed on the value that quantified the characteristic (e.g., a relative RBER of the die as compared to another die).

As an illustrative example, the family variation component 113 can measure the valley margin of the highest logical programming level of a die. In some embodiments, the family variation component 113 can perform a valley health check for the highest logical programming level of the die (e.g., level 7 of a TLC). A valley heath check can be used to verify the integrity of data stored at the block. The results of the valley health check can indicate that the voltage distribution has shifted from its programmed position. That is, the family variation component 113 can measure the threshold voltage of data stored at the highest logical programming level of the die. The threshold voltage can represent the measure of the characteristic of the die.

In some embodiments, the family variation component 113 can sort the dies according to the measure of the characteristic (e.g., according to the voltage distribution). For example, the family variation component 113 can list the dies and their corresponding characteristic measurement, e.g., from lowest to highest. The family variation component 113 can distribute the sorted dies into the die families according to the die family distribution policy. In some embodiments, the die family distribution policy indicates a percentage range for each die family. As an illustrative example, the family variation component 113 can distribute the first 18-22% dies (e.g., the dies with the lowest characteristic measurement) in the first die family, the next 18-22% dies in the second die family, etc. The family variation component 113 can start with an optimal distribution percentage (e.g., 20%), and can find an appropriate breaking point within the range (e.g., within 18-22%) at which to distribute the dies. The die family distribution policy can include instructions to group the dies that have the same characteristic measurement together in one die family. That is, if the characteristic measurement for the dies at the 20% mark overlaps with the characteristic measurement of the dies at the 19% and 21% mark, the family variation component 113 can determine group the dies in the same die family. The family variation component 113 can identify an appropriate point at which to break up the distribution of die families, within the size capacity range.

In some embodiments, the size capacity can be a maximum number of dies in each die family, and the family variation component 113 can identify an appropriate breaking point for distributing the dies among the die families according to the size capacity of each die family. For example, the size capacity for each die family can be set to a maximum of 1/x of the total number of dies, where x is one less than the total number of die families. As an illustrative example, for five die families, the size capacity for each die family can be set to a maximum of 1/4 of the total number of dies. For a memory device that has 255 dies, the size capacity for each die family can be 64 dies. Thus, the family variation component 113 can identify an appropriate breaking point for distributing the dies among the die families that is closest to the maximum size capacity.

In some embodiments, the family variation component 113 can redistribute the dies among the die families. The family variation component 113 can redistribute the dies in response to a triggering event, such as in response to reaching a certain program/erase cycle (PEC) count (e.g., every 1,000 PEC), and/or in response to the memory sub-system controller 115 performing a media management operation (e.g., a garbage collection operation).

In some embodiments, the family variation component 113 can determine a read offset value for each die family. The read offset value can be used offset the threshold voltage shift exhibited by the dies associated with each die family. The family variation component 113 can determine the read offset value by taking an average of the voltage shift measurements of the dies associated with a die family, and determining the appropriate read offset value to apply to the base read level to offset the average voltage shift measurements. When executing a read operation directed to a particular die, the family variation component 113 can identify the read offset value associated with the die family which the particular die is associated with, and can apply the read offset value to the base read level of the cell(s) being read.

In some embodiments, the family variation component 113 can implement the block family distribution policy. The block family distribution policy can serve a similar function to the die family distribution policy. In some embodiments, the goal of the block family distribution policy can be to ensure that no block family is assigned a majority of the blocks.

In some embodiments, block families are created as data is being programmed to the memory device (e.g., as data is being received from host system 120, and being stored in a memory device 130). For example, a first block family can be opened at a first point in time, and the blocks in which data is stored in response to write operations received after that first point in time can associated with a first block family. At a predetermined time (e.g., after a predetermined time period has elapsed and/or if the temperature of the memory device 130 changes more than threshold amount), the memory sub-system controller 115 can close the first block and open a second block family. The blocks in which data is stored in response to subsequent write operations can then be associated with a second block family. In some embodiments, since block families can be created in real-time (e.g., as data associated with write operations are being received), the family variation component 113 can implement the block family distribution policy in response to a triggering event. The triggering event can be, for example, determining that a size of a particular block satisfies a condition. For example, the triggering event can be determining that a size of a block family exceeds a threshold size (e.g., more than a threshold amount of blocks are assigned to a single block family). As another example, the triggering event can be determining that a size of a block family is great than the sizes of the other block families (e.g., more than certain percentage of the total blocks assigned to block families is assigned to a particular block family). As an illustrative example, the triggering event can be determining that more than 50% of the blocks currently assigned to block families are assigned to a single block family. Thus, the triggering event indicates that the distribution of blocks among the block families is imbalanced. In some embodiments, the triggering event can be reaching an amount of time after programming cells within a particular block, and/or can be every x number of PEC.

The family variation component 113 can associate each block of a set of blocks with a corresponding block family, according to the block family distribution policy. The set of blocks includes blocks have been programmed (e.g., that contain valid data). The block family distribution policy can implement an even (or almost even) distribution of blocks within the block families.

In some embodiments, the family variation component 113 can obtain the measure of the characteristic of the valid blocks, as described above and throughout. The family variation component 113 can sort the block families by the measure of the characteristic, and can apply the block family distribution policy to the sorted blocks. In some embodiments, the family variation component 113 can determine a read offset value based on the measure of the characteristic. That is, the read offset value can offset the threshold voltage shift exhibited by the measure of the characteristic. The family variation component 113 can associate the read offset value with the block family.

In some embodiments, the memory sub-system controller 115 can receive and/or identify a read operation specifying a logical address. For example, the memory sub-system controller 115 can receive a read command from host system 120. In some embodiments, in response to receiving a read operation (e.g., from the host system 120), the memory sub-system controller 115 can identify the block and/or die corresponding to the address in the read operation. For example, the read operation can include a logical address to be read, and the memory sub-system controller 115 can convert the logical address to a physical address. In some embodiments, the memory sub-system controller 115 can use a logical-to-physical table to translate the logical address to a physical address. The physical address can point to a block and/or to a die of a memory device (e.g., memory device 130). The memory sub-system controller 115 can identify the block family to which the block is associated, and/or a die family to which the block is associated. The memory sub-system controller 115 can apply the read offset associated with the die family and/or the block family to read the data at the physical address. The memory sub-system controller 115 can cause a read voltage signal to be applied to the memory device corresponding to the physical address, in order to perform the read operation. The read voltage signal can be the read base level modified by the identified read offset value associated with the die family and/or the block family with which the die and/or block of the physical address is associated.

Further details with regards to the operations of the family variation component 113 are described below.

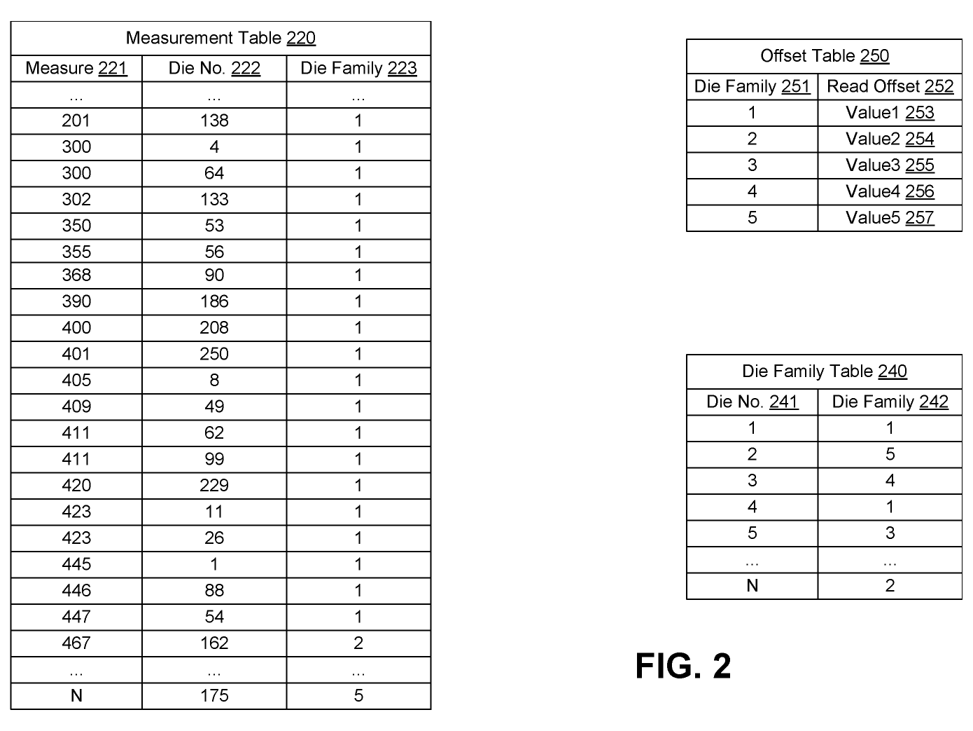

FIG. 2 illustrates example metadata maintained by the memory sub-system controller 115 for associating dies with die families, in accordance with embodiments of the present disclosure. FIG. 2

illustrates a measurement table 220, an offset table 250, and a die family table 240. In some embodiments, the family variation component 113 can maintain each table 220, 250 and/or 240 for each memory device 130, 140. In some embodiments, the family variation component 113 can store each table 220, 250, and/or 240 in local memory 119.

In some embodiments, family variation component 113 can obtain a measure of a characteristic of each die. The measure can represent a data state metric value (or values) representing the temporal voltage shift of the cells in a die. The family variation component 113 can maintain a measurement table 220, which lists each die number 222 and the corresponding measurement 221. The family variation component 113 can sort the measurement table 220 according to the measure value 221 (e.g., from lowest to highest). The family variation component 113 can then assign each die (e.g., each die number 222) to a die family 223, according to the die family distribution policy.

As an illustrative example, the die family distribution policy can indicate that the first 18-22% of dies in measurement table 220 are to be assigned to die family 1, the next 18-22% are to be assigned to die family 2, etc. As illustrated in FIG. 2, the dies that have a measure value below 460 can be associated with die family 1. The next die family can begin with the die having a measure 221 greater than 460. FIG. 2 illustrates five die families, however fewer or more die families can be used.

In some embodiments, the family variation component 113 can determine a read offset for each die family. The family variation component 113 can store the read offset in the offset table 250. Each offset value 252 can be used to offset the threshold voltage exhibited by the dies associated with the corresponding die family 251. Thus, for example, read offset value1 253 can offset the average threshold voltage shift for the die families assigned to die family 1.

In some embodiments, rather than associating each die with a die family in measurement table 220, the family variation component 113 can maintain a die family table 240. The family variation component 113 can assign each die number 241 to a die family 242.

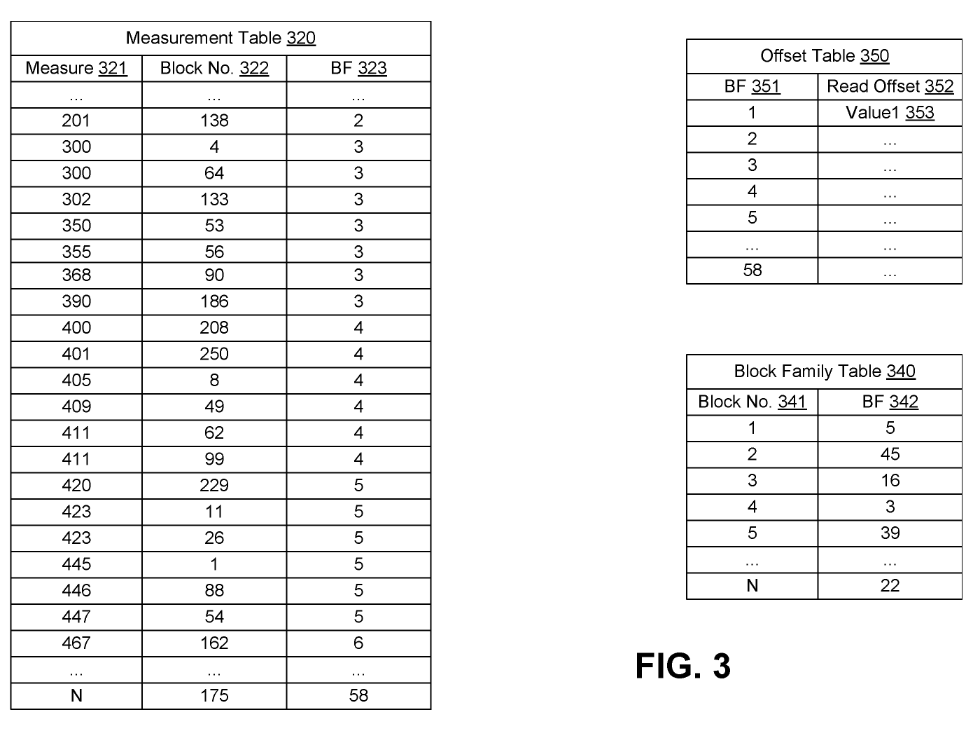

FIG. 3 illustrates example metadata maintained by the memory sub-system controller 115 for associating blocks with blocks families, in accordance with embodiments of the present disclosure. FIG. 3 illustrates a measurement table 320, an offset table 350, and a block family table 340. In some embodiments, the family variation component 113 can maintain each table 320, 350 and/or 340 for each memory device 130, 140. In some embodiments, the family variation component 113 can store each table 320, 350, and/or 340 in local memory 119.

In some embodiments, family variation component 113 can obtain a measure of a characteristic of each block. The measure can represent a data state metric value (or values) representing the temporal voltage shift of the cells in a block. The family variation component 113 can maintain a measurement table 320, which lists each block number 322 and the corresponding measurement 321. The family variation component 113 can sort the measurement table 320 according to the measure value 321 (e.g., from lowest to highest). The family variation component 113 can then assign each block (e.g., each block number 322) to a block family (BF) 323, according to the block family distribution policy.

As an illustrative example, the block family distribution policy can indicate that the first 1-2% of valid blocks in measurement table 320 are to be assigned to block family 1, the next 1-2% are to be assigned to block family 2, etc. As illustrated in FIG. 3, the blocks that have a measure value between 300 and 400 can be associated with block family 3. The blocks that have a measure value between 400 and 420 can be associated with block family 4. FIG. 3 illustrates five 58 families, however fewer or more block families can be used.

In some embodiments, the family variation component 113 can determine a read offset for each block family. The family variation component 113 can store the read offset in the offset table 350. Each offset value 352 can be used to offset the threshold voltage exhibited by the blocks associated with the corresponding block family 351. Thus, for example, read offset value1 353 can offset the average threshold voltage shift for the block families assigned to block family 1.

In some embodiments, rather than associating each block with a block family in measurement table 320, the family variation component 113 can maintain a block family table 340. The family variation component 113 can assign each block number 341 to a block family 342.

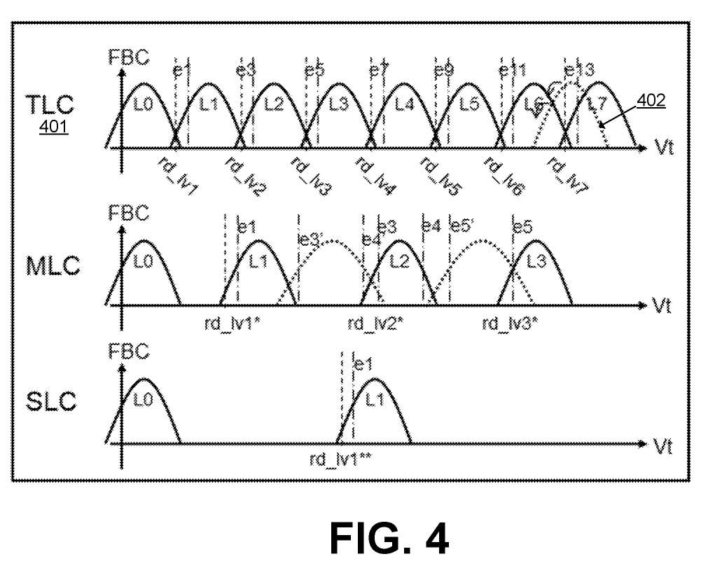

FIG. 4 illustrates an example of the threshold voltage shifts for each logical programming level of a die measured by the family variation component 113, in accordance with some embodiments of the present disclosure. As illustrated in FIG. 4, the TLC graph 401 shows the voltage distribution of each level (L0 through L7) at a first point in time (e.g., at the time of programming). The dashed line 402 shows the threshold voltage shift for L7 after a certain amount of time has elapsed. That is, the dashed line 402 shows the threshold voltage shift for L7 at an amount of time after programming (TAP). To determine the threshold voltage shift for L7, the family variation component 113 can measure the difference between the solid line L7 and the dashed line 402. The family variation component 113 can determine and/or obtain the threshold voltage shift for L7 for a subset of cells of each block, and/or for a subset of cells of each die. The family variation component 113 can populate the measurement table 220 and/or measurement table 320 with the measured threshold voltage shift. In the some embodiments, the measure 221 of measurement table 220 is the average of the threshold voltage shift for L7 for the subset of cells of a block at a point in time, and the measure value 321 of measurement table 320 is the average of the threshold voltage shift for L7 for the subset of cells of a die at a point in time. The family variation component 113 can measure and/or obtain the threshold voltage shift in response to a triggering event (e.g., at every x PEC, in response to determining that a block family and/or die family has exceed a size threshold), and/or upon a power-on event of the memory sub-system 110. In some embodiments, the family variation component 113 can determine and/or obtain the measure the threshold voltage shift in response to initiating the process of implementing the die family distribution policy and/or the block family distribution policy.

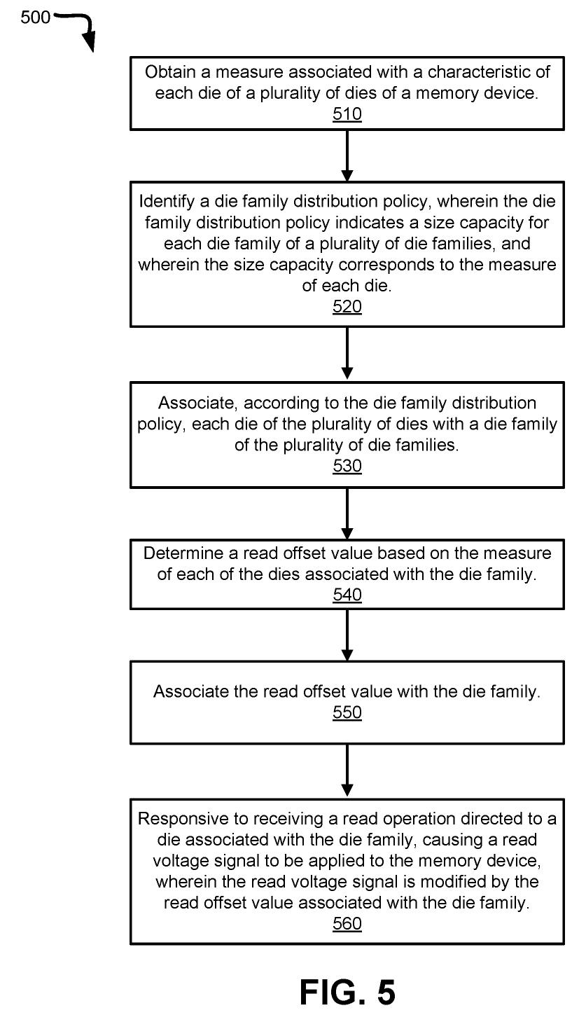

FIG. 5 is a flow diagram of an example method 500 to distribute dies into die families, in accordance with some embodiments of the present disclosure. The method 500 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 500 is performed by the family variation component 113 of FIG. 1.

Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 510, the processing logic obtains a measure associated with a characteristic of each die of a plurality of dies of a memory device (e.g., of memory device 130 of FIG. 1). In some embodiments, the measure can represent the threshold voltage distribution of memory cells in each die. The processing logic can measure the valley margin of the highest voltage distribution valley for one or more cells of each die. For example, for TLC, processing logic can measure the voltage distribution for valley 7 (e.g., as described with respect to FIG. 4).

At operation 520, the processing logic identifies a die family distribution policy that indicates a size capacity for each die family of a plurality of die families. The size capacity corresponds to the measure of each die. In some embodiments, the die family distribution policy can be stored in local memory (e.g., local memory 119 of FIG. 1). In some embodiments, processing logic can identify a die family distribution policy that corresponds to the particular memory device (e.g., memory device 130 of FIG. 1). In some embodiments, the size capacity of each die family in the die family distribution policy is relative to the respective size capacity of the other die families, and/or the size capacity represents a maximum number of dies assigned to the die family.

At operation 530, the processing logic associates, according to the die family distribution policy, each die of the plurality of dies with a die family of the plurality of die families. In some embodiments, the processing logic can sort the plurality of dies according to the measure associated with the characteristic of the die (e.g., as illustrated and described with respect to table 220 of FIG. 2).

At block 540, the processing logic determines read offset value for each die family. The read offset value can be based on the measure associated with the characteristic of each die. The read offset value can be applied to read operations, to offset the measured shift of the cells assigned to the die family. In some embodiments, the read offset value for a particular die family can correspond to the average of the measure associated with characteristics of each die associated with the particular die family. In some embodiments, the read offset value for a particular die family can correspond to the median or mode of the measure associated with characteristics of each die associated with the particular die family.

At block 550, the processing logic associates the read offset value with the corresponding die family. In some embodiments, as an illustrative example, the processing logic can update the metadata described with respect to FIG. 2. For example, the processing logic can add and/or update the read offset value 252 in offset table 250 for the corresponding die family 251.

At block 560, in response to receiving (or identifying) a read operation directed to a die associated with the die family, the processing logic causes a read voltage signal to be applied to the memory device. The processing logic can modify the read voltage signal by the read offset value associated with the die family. That is, when executing the read operation, the processing logic can apply the read offset value to the base read level of the address identified by the read operation.

In some embodiments, in response to a triggering event, the processing logic can redistribute the dies into the die families according to the die family distribution policy. The triggering event can be, for example, the performance of a media management operation, or every x number of program/erase cycles (PEC). To redistribute the dies into die families, the processing logic can perform operations 510-530. In response to redistributing the dies into the die families, the processing logic can determine an updated read offset value based on updated measures, and associated the updated read offset value with each die family.

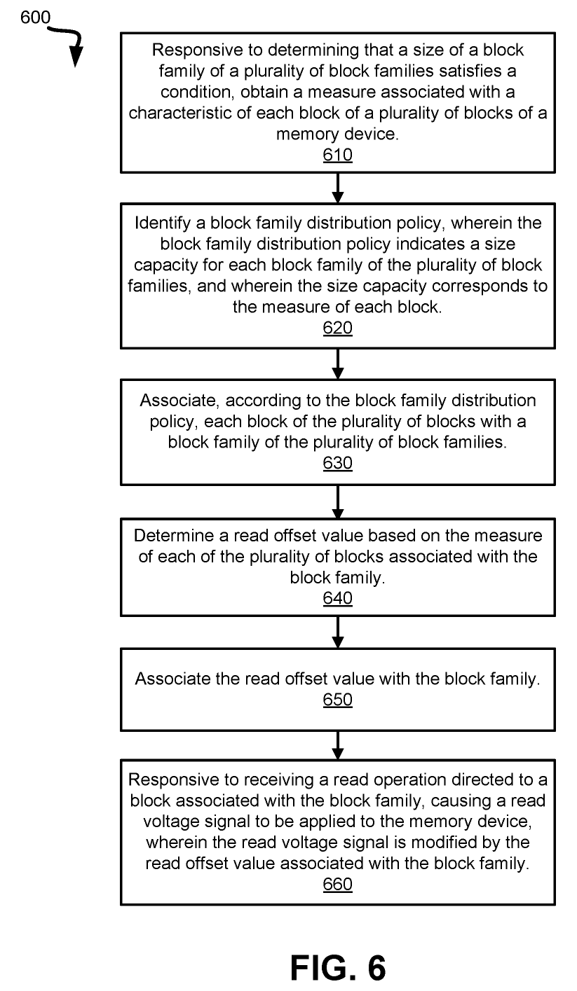

FIG. 6 is a flow diagram of an example method 600 to distribute block into block families, in accordance with some embodiments of the present disclosure. The method 600 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 600 is performed by the family variation component 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 610, responsive to determining that a size of a block family of a plurality of block families satisfies a condition, the processing logic obtains a measure associated with a characteristic of each block of a plurality of blocks of a memory device. The size of the block family represents the number of blocks associated with the block family. The size of a block family can satisfy the condition by exceeding a threshold amount (e.g., by becoming too large). In some embodiments, the threshold amount can be a number of blocks (e.g., the size of the block family can satisfy the condition by exceeding a predetermined number of blocks assigned to the block family). In some embodiments, the threshold amount can be a percentage of the total number of blocks (e.g., the size of the block family can satisfy the condition if the number of blocks assigned to the block family is greater than 40% of the total number of blocks).

In some embodiments, the measure can represent the threshold voltage distribution of memory cells in each block. The processing logic can measure the valley margin of the highest voltage distribution valley for one or more cells of each block. For example, for TLC, processing logic can measure the voltage distribution for valley 7 (e.g., as described with respect to FIG. 4).

At operation 620, the processing logic identifies a block family distribution policy that indicates a size capacity for each block family of the plurality of block families. The size capacity corresponds to the measure of each block. In some embodiments, the block family distribution policy can be stored in local memory (e.g., local memory 119 of FIG. 1). In some embodiments, processing logic can identify a block family distribution policy that corresponds to the particular memory device (e.g., memory device 130 of FIG. 1).

In some embodiments, the size capacity for a respective block family is relative the size capacity of the other block families, and/or the size capacity represents a maximum number of blocks associated with the block family.

At operation 630, the processing logic associates, according to the block family distribution policy, each block of the plurality of blocks with a block family of the plurality of blocks families. In some embodiments, the processing logic can sort the plurality of blocks according to the measure associated with the characteristic of the die (e.g., as illustrated and described with respect to table 320 of FIG. 3).

At block 640, the processing logic determines a read offset value for each block family. The read offset value can be based on the measure associated with the characteristic of each block. The read offset value can be applied to read operations, to offset the measured shift of the cells assigned to the block family. In some embodiments, the read offset value for a particular block family can correspond to the average of the measure associated with characteristics of each block associated with the particular block family. In some embodiments, the read offset value for a particular block family can correspond to the median or mode of the measure associated with characteristics of each block associated with the particular block family.

At block 650, the processing logic associates the read offset value with each block family. In some embodiments, as an illustrative example, the processing logic can update the metadata described with respect to FIG. 3 . For example, the processing logic can add and/or update the read offset value 352 in offset table 350 for the block die family 351. At block 660, in response to identifying (e.g., receiving) a read operation directed to a block associated with the block family, the processing logic causes a read voltage signal to be applied to the memory device. The processing logic can modify the read voltage signal by the read offset value associated with the block family. That is, when executing the read operation, the processing logic can apply the read offset value to the base read level of the address identified by the read operation.

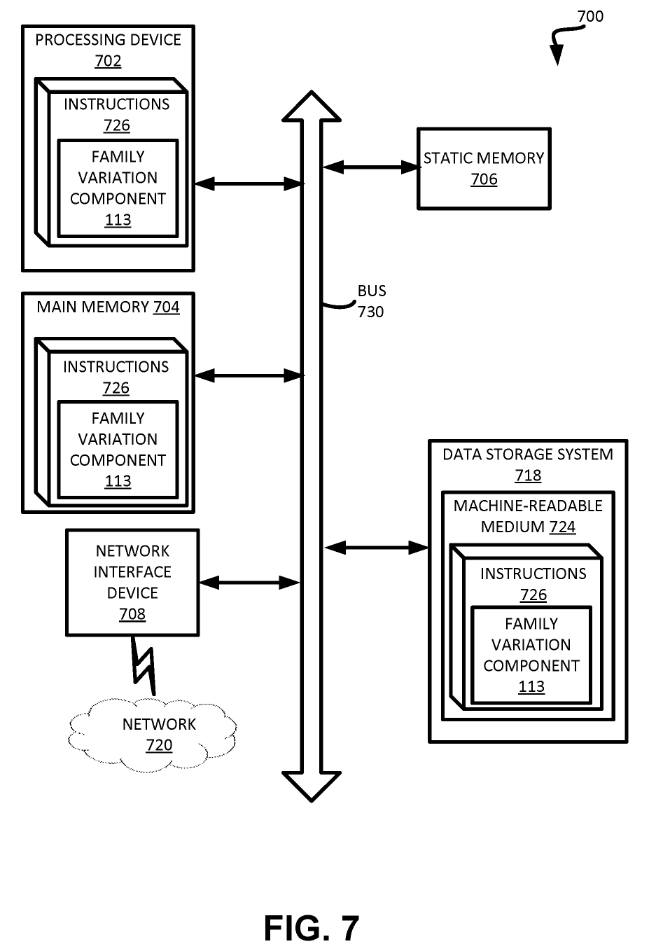

FIG. 7 illustrates an example machine of a computer system 700 within which a set of instructions, for causing the machine to perform any one or more of the methodologies discussed herein, can be executed. In some embodiments, the computer system 700 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to the family variation component 113 of FIG. 1). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 700 includes a processing device 702, a main memory 704 (e.g., read-only memory (ROM), flash memory, dynamic random access memory (DRAM) such as synchronous DRAM (SDRAM) or RDRAM, etc.), a static memory 706 (e.g., flash memory, static random access memory (SRAM), etc.), and a data storage system 718, which communicate with each other via a bus 730.

Processing device 702 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 702 can also be one or more special-purpose processing devices such as an application specific integrated circuit (ASIC), a field programmable gate array (FPGA), a digital signal processor (DSP), network processor, or the like. The processing device 702 is configured to execute instructions 726 for performing the operations and steps discussed herein. The computer system 700 can further include a network interface device 708 to communicate over the network 720.

The data storage system 718 can include a machine-readable storage medium 724 (also known as a computer-readable medium) on which is stored one or more sets of instructions 726 or software embodying any one or more of the methodologies or functions described herein. The instructions 726 can also reside, completely or at least partially, within the main memory 704 and/or within the processing device 702 during execution thereof by the computer system 700, the main memory 704 and the processing device 702 also constituting machine-readable storage media. The machine-readable storage medium 724, data storage system 718, and/or main memory 704 can correspond to the memory sub-system 110 of FIG. 1.

In one embodiment, the instructions 726 include instructions to implement functionality corresponding to a family variation component (e.g., the family variation component 113 of FIG. 1 ). While the machine-readable storage medium 724 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A system comprising:
a memory device; and
a processing device, operatively coupled with the memory device, to perform operations comprising:
obtaining a measure associated with a characteristic of each die of a plurality of dies of the memory device;
identifying a die family distribution policy, wherein the die family distribution policy indicates a size capacity for each die family of a plurality of die families, and wherein the size capacity corresponds to the measure of each die; and
associating, according to the die family distribution policy, each die of the plurality of dies with a die family of the plurality of die families.

2. The system of claim 1, wherein the operations further comprise:
determining a read offset value based on the measure of each of the dies associated with the die family;
associating the read offset value with the die family; and
responsive to receiving a read operation directed to a die associated with the die family, causing a read voltage signal to be applied to the memory device, wherein the read voltage signal is modified by the read offset value associated with the die family.

3. The system of claim 1, wherein the operations further comprise:
sorting the plurality of dies of the memory device according to the measure associated with the characteristic of the die.

4. The system of claim 1, wherein at least one of: (1) the size capacity of each die family is relative to the respective size capacity of one or more additional die families of the die, or (2) the size capacity represents a maximum number of dies assigned to the die family.

5. The system of claim 1, further comprising:
responsive to a triggering event, redistributing, according to the die family distribution policy, the plurality of dies to the plurality of die families.

6. The system of claim 5, further comprising:
responsive to redistributing the plurality of dies to the plurality of die families, determining a second read offset value based on updated measures of each of the dies assigned to a die family; and
associating the second read offset value with the die family.

7. The system of claim 1, wherein obtaining the measure associated with the characteristic of each of the plurality of dies comprises:
measuring a valley margin of a highest voltage distribution valley for one or more cells of each die.

8. A method comprising:
responsive to determining that a size of a block family of a plurality of block families satisfies a condition, obtaining a measure associated with a characteristic of each block of a plurality of blocks of a memory device;
identifying a block family distribution policy, wherein the block family distribution policy indicates a size capacity for each block family of the plurality of block families, and wherein the size capacity corresponds to the measure of each block; and
associating, according to the block family distribution policy, each block of the plurality of blocks with a corresponding block family of the plurality of block families.

9. The method of claim 8, further comprising:
determining a read offset value based on the measure of each of the plurality of blocks associated with the block family;
associating the read offset value with the block family; and
responsive to receiving a read operation directed to a block associated with the block family, causing a read voltage signal to be applied to the memory device, wherein the read voltage signal is modified by the read offset value associated with the block family.

10. The method of claim 8, wherein the condition compares the size of the block family to at least one of: (1) a corresponding size of one or more additional block families, or (2) a threshold size.

11. The method of claim 8, wherein the size represents a number of blocks associated with the block family.

12. The method of claim 8, wherein at least one of: (1) the size capacity for a respective block family of the plurality of block families is relative to the respective size capacity of one or more additional block families of the plurality of block families, or (2) the size capacity represents a maximum number of blocks associated with the block family.

13. The method of claim 8, wherein obtaining the measure associated with the characteristic of each of the plurality of blocks comprises:
measuring a valley margin of a highest voltage distribution valley for one or more cells of each block.

14. A non-transitory computer-readable storage medium comprising instructions that, when executed by a processing device, cause the processing device to perform operations comprising:
obtaining a measure associated with a characteristic of each die of a plurality of dies of a memory device;
identifying a die family distribution policy, wherein the die family distribution policy indicates a size capacity for each die family of a plurality of die families, and wherein the size capacity corresponds to the measure of each die; and
associating, according to the die family distribution policy, each die of the plurality of dies with a die family of the plurality of die families.

15. The non-transitory computer-readable storage medium of claim 14, wherein the operations further comprise:
determining a read offset value based on the measure of each of the dies associated with the die family;
associating the read offset value with the die family; and
responsive to receiving a read operation directed to a die associated with the die family, causing a read voltage signal to be applied to the memory device, wherein the read voltage signal is modified by the read offset value associated with the die family.

16. The non-transitory computer-readable storage medium of claim 14, wherein the operations further comprise:
sorting the plurality of dies of the memory device according to the measure associated with the characteristic of the die.

17. The non-transitory computer-readable storage medium of claim 14, wherein at least one of: (1) the size capacity of each die family is relative to the respective size capacity of one or more additional die families of the die, or (2) the size capacity represents a maximum number of dies assigned to the die family.

18. The non-transitory computer-readable storage medium of claim 14, further comprising:
responsive to performing a media management operation, redistributing, according to the die family distribution policy, the plurality of dies to the plurality of die families.

19. The non-transitory computer-readable storage medium of claim 14, further comprising:
responsive to redistributing the plurality of dies to the plurality of die families, determining a second read offset value based on updated measures of each of the dies assigned to a die family; and
associating the second read offset value with the die family.

20. The non-transitory computer-readable storage medium of claim 14, wherein obtaining the measure associated with the characteristic of each of the plurality of dies comprises:
measuring a valley margin of a highest voltage distribution valley for one or more cells of each die.
